(19) United States
(12) Patent Application Publication
(10) Pub. No.: US 2012/0177884 A1
(43) Pub. Date: Jul. 12, 2012

(54) TRANSPARENT TEXTURED COATING SURFACES FROM WATER EVAPORATION

(76) Inventor: Richard M. Jones, Oak Ridge, NJ (US)

(21) Appl. No.: 13/496,520

(22) PCT Filed: Sep. 16, 2010
(86) PCT No.: PCT/US10/02541

§ 371 Date: Mar. 16, 2012

Related U.S. Application Data
(60) Provisional application No. 61/242,972, filed on Sep. 16, 2009.

(51) Int. Cl. B05D 5/00; C08K 3/34; B32B 5/16; C08K 5/11; C08K 5/1515; C09D 5/00; C09D 101/00

(52) U.S. Cl. 428/146; 427/256; 427/504; 106/287.22; 106/287.24; 106/626; 106/162.9; 524/310; 524/114; 428/149; 428/147

(57) ABSTRACT

A coating solution for textured surfaces can comprise water, a water-soluble or water-dispersible organic binder which preferably is radiation curable, and a dispersion of particles and/or their preformed aggregates having a refractive index either larger, matching, or smaller than a refractive index of the organic binder or its cured polymer. Two refractive indices can be chosen, depending upon whether a textured surface appearance of frost, transparency, or ultralow reflectivity, respectively, is desired. Water evaporation from energy curable coatings can be used, preferably containing a high loading of insoluble and/or non-swelling particles and their aggregates, at least one of whose dimensions are preferably larger than the dried film, so as to expose these particles or their aggregates at the surface and cure the film to lock them into place. The coating solution can be used to achieve a textured coated result useable in direct (and indirect) food contact.

### CROSS-REFERENCE TO RELATED APPLICATIONS:

The present application claims priority to U.S. Provisional Patent Application No. 61/242,972, filed on Sep. 16, 2009, the disclosure of which is hereby incorporated herein by reference.

### TECHNICAL FIELD

The present invention is directed to textured coatings, and in particular to using water containing coatings to achieve textured surfaces having various degrees of transparency and gloss via water evaporation.

### BACKGROUND OF THE INVENTION

There is a wide-spread need for packaging that is both free of volatile organic compounds (“VOCs”) and available in a variety of textures and degrees of transparency and glossiness.

For example, many products are packaged in transparent plastic bags or other containers, and graphics are either printed on the inside of the container and/or on the contained product itself or on a label affixed to it. Thus, transparency of the container is desired. At the same time, for a variety of psychological and marketing reasons, the packaging of many of these products is desired to both appear and actually feel “softer” than standard high-gloss plastics. Such a “softer” feel and look is believed to suggest “comfortable”, “pleasing”, “natural”, “non-artificial”, “green” and similar emotions and associations. This is in contradistinction to the standard shiny high-gloss plastic or cellophane packaging that has been ubiquitous in the past.

Additionally, for food packaging, it is necessary to avoid most VOCs, as well as project a “natural” “wholesome” and “healthy” image for the food being packaged. The concern for VOCs and other non-safe chemicals and additives applies both to the interior side of a food package as well as to its outside. This is because such packaging is often wound on large rolls, where the ultimate outer side of the plastic package touches the side that ends up as being the interior. Thus, there is a need for special effect and transparent packaging suitable for use with food products.

Conventionally, textured surfaces are typically made by, for example, embossing, chemical etching, molding of particle-loaded plastic, spray coating of polymer/particle dispersions containing volatile solvent(s), and precipitation of polymer from a dispersion or emulsion.

Conventional frost effect and spray application coatings are widely available in hardware stores. They typically contain a polymeric binder, a dispersion of particles, and a volatile solvent. The solvent evaporates during the spray application, thus leading to a condition of less binder liquid than would be required to fluidize the resulting loading of particles. This condition, in turn, creates a high viscosity after-spray and affixes the particles to the sprayed surface. The binder then “cures” by film formation or air drying as in a normal emulsion or lacquer paint. The result is an abundance of particles or their aggregates protruding from the applied polymer film to produce the desired texture as a whitish, opaque coating commonly perceived as “frost.”

These conventional approaches suffer from the fact that such a coating is opaque, as well as from the fact that the VOCs and other chemical components they contain can be both flammable as well as toxic. Even if not toxic, their use requires compliance with VOC regulations and limitations, and thus may not be practical in many contexts, especially, for example, food related packaging, preparation, display and other uses.

Water has sometimes been used in the creation of textured or structured surfaces. For example, U.S. Pat. No. 7,244,508 teaches the use of water evaporation to create particle aggregates. However, this approach requires controlled heat over a period of time in an oven to generate a high surface area, continuous, well-adhered film, thus requiring complex apparatus and energy use.

Radiation curing has also been applied to the formation of a textured surface. For example, U.S. Pat. No. 6,476,093 describes silica filled coating liquids comprising a radiation curing monomer and, inter alia, a volatile solvent to generate frost-effect coatings that pass alkali and impact tests on glass. However, water is not contemplated as a possible solvent, and water is not a realistic choice in such systems inasmuch as few radiation cure monomers are compatible with water. Additionally, the use of the volatile solvents precludes direct food contact with these coatings.

A description of the combination of radiation curing and aggregate formation appears in U.S. Pat. No. 6,777,092. Here again, evaporation of an organic solvent (ethanol) is required to achieve polymer precipitation.

Writable and ink-receptive coatings are described U.S. Pat. No. 6,251,512 as well as in WO 1998005512. However, these systems involve transparent coatings comprising water-swelling particles, and are described as receptive to marking by water-based and oil-based inks. The particles are to swell in water to accept 2-20 ml of water per gm of particle, and substantial particle loading is contemplated (preferably 60% to 100%). Such loading would preclude printing by flexography, gravure, ink-jet and the like, and thus is inconsistent with both these printing technologies as well as most packaging technologies.

What is needed in the art is a new type of textured coating and a method of applying same that solves the above-identified problems in the prior art.

What is further needed is a coating solution and method of applying same that can be transparent or “frost-like”, yet at the same time can be capable of various textures and gloss, that can be used in direct food contact and related contexts.

### SUMMARY OF THE INVENTION

A coating solution for textured surfaces is presented. In exemplary embodiments of the present invention, a coating solution can comprise water, a water-soluble or water-dispersible organic binder which preferably is radiation curable, and a dispersion of particles and/or their preformed aggregates having a refractive index either larger, matching, or smaller than a refractive index of the organic binder or its cured polymer. In exemplary embodiments of the present invention, the two refractive indices can be chosen, depending upon whether a textured surface appearance of frost, transparency, or ultralow reflectivity, respectively, is desired. In exemplary embodiments of the present invention, water evaporation from energy curable coatings can be used, preferably containing a high loading of insoluble and/or non-swelling particles and their aggregates, at least one of whose dimensions are preferably larger than the dried film, so as to expose these particles or their aggregates at the surface and cure the film to lock them into place. This process can be easily adapted to any coater or press where current radiation cured overcoats are applied, such as, for example, flexography or gravure. Further, a process is presented that uses such a coating solution to achieve a textured surface effect on various substrates, such as, for example, glass, metal, wood, paper or plastic by simple coating and drying/curing. In exemplary embodiments of the present invention the coating solution and process can be used to achieve a textured coated result useable in direct (and indirect) food contact by virtue of having an extraction result below that regulated by the FDA or other appropriate regulatory agency or authority.

### DETAILED DESCRIPTION OF THE INVENTION

In exemplary embodiments of the present invention, water-based and environmentally sound technology can be combined with natural product derived critical elements to deliver a coating that is compliant with applicable FDA (or other appropriate agency) regulations for direct food contact for use in packaging. In exemplary embodiments of the present invention, flexographic printing and radiation curing to set the films can be used, resulting in low energy consumption and low hazard. In flexography, there is no waste liquid, and with radiation cure there is no need for using a highly volatile solvent or for oven drying.

In contrast to the prior art, in exemplary embodiments of the present invention one or more of the following features can be used: (1) water as solvent; (2) radiation curing to affix the particles; (3) natural product-derived particles that yield transparency while at the same time produce very low gloss; and (4) a process that is compliant with FDA, or other appropriate regulatory agency, regulations for direct food contact.

A frosted appearance with high transparency is not readily achievable from the use of typical matting agents. While this type of surface is available by embossing plastic film, such a process is costly and requires lamination to use it above printed surfaces. In exemplary embodiments of the present invention, water evaporation from energy curable coatings can be used, preferably containing a high loading of insoluble and/or non-swelling particles and their aggregates, at least one of whose dimensions are preferably larger than the dried film, so as to expose these particles or their aggregates at the surface and cure the film to lock them into place. This process can be easily adapted to any coater or press where current radiation cured overcoats are applied, such as, for example, flexography or gravure. To achieve transparency and low gloss (for example 10-30% at 60 deg viewing angle), insoluble particles with an index of refraction near that of the water-miscible radiation cure monomers can, for example, preferably be used (such as, for example, where n=1.4-1.5 at 1-30% by weight). Given a binder with a given refractive index, the lower the particle refractive index and the higher the percent solids, the lower the gloss, and thus, the greater the frost effect. On the other hand, the closer the particle refractive index is to that of the binder, the greater the transparency. Thus a wide variety of optical effects are possible by careful selection of binder and particle, including the delivery of an ultralow gloss (<10% at 85 deg) together with transparency. This latter novel combination is simply a contradiction in conventional approaches, and not possible.

It is noted that the approach of the present invention is less costly, and thus more efficient, than prior art methods, particularly those requiring lamination. It is also widely applicable on most flexographic or gravure presses and offers a path to low gloss surfaces that retain the ability for user or viewer to clearly see printed graphics or contents underneath (such as, for example, inside a package or a display case). In exemplary embodiments of the present invention, the novel coatings and methods can be applied a wide variety of substrates, such as, for example, glass, metal, wood, paper, and plastic. In addition, direct contact food packaging can be addressed by the use of, for example, Sun Chemical's LO/LE™ technology, or the like, with food grade natural polymers such as, for example, starch and cellulose or certain dispersed synthetic polymer particles, whose direct extractables fall below regulatory limits. As noted, having a textured surface combined with the transparency to see packaging contents or underlying graphics is an attractive, and highly desirable, combination. As noted, the delivery of ultralow gloss (<10% at 85 deg) together with transparency is simply unknown, and not possible, in conventional approaches.

Additionally, in contrast to conventional approaches, in exemplary embodiments of the present invention, the particles used for the texturing effects do not swell with water—either in the aqueous coating solution, or after application and curing. For this reason, organic-compatible solids can be used, and, to the extent that natural products are desired, hydrophobic derivatives of starch and cellulose that do not swell in water can, for example, be utilized.

In exemplary embodiments of the present invention, the achievement of a frosted appearance relies on the water preferably being soluble or stably dispersed in the binder and then evaporating in a manner similar to how organic solvents evaporate from commercial spray coatings. This effect can be enhanced, for example, by the use of a particular type of radiation cure monomer such as, for example, that described in Sun Chemical's patented FDA-compliant LO/LE™ technology, as described, for example, in U.S. Pat. No. 6,803,112, the entirety of which is incorporated herein by reference.

When the water evaporates, either before or during radiation curing, the thickness of the binder decreases. By varying the refractive index of the particles relative to the refractive index of the binder, various special visual effects can be achieved. For example, if the particles are similar in refractive index to the binder, the textured film that results can be largely transparent. Alternatively, if the particles have a slightly lower index of refraction than the binder, the resulting surface can be extremely low gloss. The achievement of ultralow gloss, such as, for example, <10% at 85 deg, combined with transparency from a simple coating is unique in the industry. In exemplary embodiments of the present invention these attributes can be accomplished by the evaporation of water from a wet coating, thereby exposing particles or their preformed agglomerates to create a roughened surface. Additionally, if binders such as those provided in Sun Chemical's LO/LE™ chemistry are used, which cures in electron beam to yield ppb extractables, and, for example, no other volatile or migrating molecule is used that is not present in an LO/LE™ type system, the resulting film can, for example, be compliant with FDA regulations (or other appropriate regulations, as the case may be) for direct food contact.

In exemplary embodiments of the present invention, the particles can be, for example, chosen for their size, the size of their agglomerate(s), and their refractive index. As noted, refractive index match to the binder yields transparency, while large refractive index mismatch yields frosted or low reflectivity, largely opaque coatings. Though a preferred method of application can be, for example, gravure or flexographic printing, in exemplary embodiments of the present invention an exemplary coating can be applied by other methods, such as, for example, lithography, spray, screen printing, knife coating, rod coating, etc. In exemplary embodiments of the present invention, a wide variety of substrates can be thus overcoated, such as, for example, metal, glass, wood, paper, or plastic with or without printed graphics underneath. In exemplary embodiments of the present invention such a coating can also accept overprinting, such as, for example, for bar coding and the like.

In exemplary embodiments of the present invention, a composition of matter that can be used as a coating comprises water, a water-soluble or water-dispersible organic binder that is preferably radiation curable, and a dispersion of particles or their preformed aggregates, where such particles or their aggregates have a refractive index either (i) larger than, (ii) substantially equal to, or (iii) smaller than that of the organic binder or its cured polymer, depending, respectively, upon whether a textured surface appearance of frost, transparency, or ultralow reflectivity is desired. In exemplary embodiments of the present invention, the particle or its aggregate can be, at least in one dimension, larger on average than the dried binder thickness such that it or its aggregate protrudes at least in part from the binder film after curing is complete. In exemplary embodiments of the present invention the water content can be, for example preferably above approximately 20% to achieve significant binder dimension reduction upon drying, and the particle loading can, for example, preferably be above approximately 2%.

In exemplary embodiments of the present invention a process can be provided using such a composition of matter to achieve a textured surface effect on various substrates, such as, for example, glass, metal, wood, paper or plastic, by simple coating and drying/curing. In exemplary embodiments of the present invention such a process can, for example, include spray coating, screen printing, knife coating, rod coating, gravure printing, or flexographic printing to apply the composition followed by radiation curing with all or a part of the water in place. Moreover, it is noted, prior drying is not essential.

In exemplary embodiments of the present invention, a cured article can be created. Such an exemplary article can include a radiation cured binder and particles and/or their aggregates, where said particles or their aggregates have a refractive index that is either larger than, substantially equal to, or smaller than, that of the binder depending upon whether a textured surface appearance of frost, transparency, or ultralow reflectivity is desired.

Exemplary uses of such cured articles can include, for example, electrical displays (either light emitting diodes or electroluminescent), light control coatings (as in computer screens to prevent off-angle viewing), labels, decals and stickers for interest, and packaging materials wherever a tactile and visual effect of frost, transparency, gloss or their combination is desired to enhance or differentiate. There are thus many uses where a combination of ultralow gloss and transparency can be beneficial.

In exemplary embodiments of the present invention, a coating composition and process can be used to achieve a textured coated result suited, for example, to direct food contact by virtue of having an extraction result below that regulated by the FDA, or other applicable regulatory agencies. FDA (or equivalent agency) compliance for direct food contact for such surfaces is of considerable commercial importance. It is noted that while surface texture and FDA (or equivalent agency) compliance are currently available by lamination of embossed or filled thin plastic films for plastics, and laser patterning and/or chemical etching for glass, both approaches are costly and often limited in available applications. To achieve these attributes by a coating applied after graphics have already been added would be more suited to the variety of films and containers used in today's food, cosmetic, and drug packaging. Such an exemplary coating can be applied by, for example, spray, screen printing, knife coating, rod coating, gravure, or flexographic printing, to name a few. In addition, in exemplary embodiments of the present invention the coating can contain no VOC or flammable solvent, and can be radiation curable to allow low viscosity application, yet still have the properties of a high molecular weight polymer after curing without the need for extended heating or oven drying.

Conventionally, a lower gloss surface is often achieved with so-called matting agents. These are small-particle, dispersed, insoluble additives to a coating liquid. Most commonly they are silica, wax, or polymer emulsions in a size range of from several hundred nanometers to one micron. Their dispersion in an organic binder does not lead to a frosted surface, nor is the result transparent if the additive is in sufficient quantity to achieve a gloss below 20%, inasmuch as there is no matching of refractive index and particle loading is too high. Thus, the results of using such conventional matting agents is often characterized by a strong haze from internal light scattering in the coating.

In contrast, frosted appearance products originate from application of a coating of a dispersion of larger particles in the size range of several microns in a largely volatile binder or in-situ formation of such particles or aggregates in a largely volatile binder. When the binder dries by solvent evaporation, the binder coating thickness is reduced to less than that of the dispersed particle or its aggregate dimension, and consequently the particle or its aggregate protrudes from the coating surface. These are easily recognized by the eye as frost effect and characterized by a low, high-angle gloss. In general, an ultralow gloss (<10% at 85 deg) can be achieved with low refractive index particles (such as, for example, where n=1.3-1.5 at 1-30% by weight) and an opaque, frosted glass appearance can be achieved by particles having a very high refractive index (for example n>1.5 at 1-30% w/w).

It is noted that the replacement of conventional volatile solvents with water is also environmentally beneficial. The use of water requires that the organic binder be at least partially miscible with water or be present as a stable emulsion. In exemplary embodiments of the present invention, to achieve sufficient dry-down dimension reduction, the water content can preferably be, for example, above 20% by weight, and more preferably can be, for example, above 30% by weight in the final blend. To achieve sufficiently low viscosity as is required for spray and gravure printing, the binder should ideally be, for example, a monomer that is cured after application, or, for example, a film-forming, low Tg emulsion polymer. Various epoxy acrylates, such as, for example, those used in Sun Chemical's LO/LE™ product line, are particularly suited for this application, such as, for example, BASF LR8765, Sartomer CN132 and the like. For radiation curing of the aqueous solutions, no prior drying is required as would be the case for emulsion polymers. As noted, replacing volatile solvents with water (as well as the use of LO/LE™ type binders) allows the resulting film to be compliant with FDA (or equivalent agency) regulations for direct food contact.

In exemplary embodiments of the present invention, the solid used to create the roughened surface can be insoluble in the binder and water, and can have at least one dimension larger than the anticipated binder thickness either in the particle itself or its aggregate.

In exemplary embodiments of the present invention different effects can be created using various relationships between the respective refractive indices of the particles and the binders being used. For example, to generate an effect similar to chemically etched glass, the refractive index of the particle can, for example, be higher than that of the binder, ideally, for example, >1.50 when compared to, for example, a range of 1.43-1.46, or, for example, 1.42-1.48, for most radcure materials. To generate a low-gloss, transparent coating, however, the particle refractive index can preferably match that of the organic binder, and finally, to generate a very low reflectivity coating, the particle refractive index would preferably be below that of the binder, ideally <1.40. In exemplary embodiments of the present invention, a preferred high refractive index particle can be, for example, talc, due to its lack of associative thickening. Thus, the most preferred index of refraction matching particles are derivatives of starch and cellulose reacted with alkylating agents to remove or greatly reduce their compatibility with water. Most low index of refraction particles are perfluorinated ethers and polyolefins but the most preferred for over-printability are also starch and cellulose derivatives with higher degrees of alkylation. The particle loading would preferably be such that the water is required to make an acceptable coating viscosity, preferably above 10% by weight and more preferably above 20% by weight. For non-food contact applications, the refractive index of the binder can also be varied to match the dispersed solid particles by addition of alternative monomers of lower or higher refractive index.

The examples provided below represent possible embodiments of each of these types of optical effect coatings. It is understood that the actual amounts of materials in the coatings can be altered to give an almost limitless range of optical effects. The coating can be applied by a variety of means but preferably would be of wet thickness larger than the average particle size of the added solid. The effect can be, for example, enhanced by prior evaporation of water (before curing) in certain contexts, but this is not a required condition. It is noted in this context that the need and/or efficacy of such a prior water evaporation step is system dependent. Some machines generate sufficient heat, for example, that once the coating is applied, but before it is cured, for example, by electron beam or UV lamp, sufficient water evaporates to obviate any additional water evaporation step. Other machines, for example, run cooler, or lack a heat exhaustion system that is proximate to the coating on press after application, or have other attributes such that less water evaporates prior to curing. In exemplary embodiments of the present invention, the curing can either be via electron beam which is preferred for minimum extractability (no photo-initiator or its fragments after irradiation) or ultraviolet light which is preferred for its heat which helps drive off the water prior to and during cure.

In exemplary embodiments of the present invention, other materials can be used that are typically found in printing inks and coating as additional components of the coating solution. For example, surfactants for substrate wetting, dispersion aides for particle stabilization, UV stabilizers for improved package stability, pigments and/or dyes for coloration, fluorescent brighteners to overcome yellowing, photoinitators for UV curing, plasticizers for increased flexibility oxygen scavengers (e.g., amines) for cure-enhancement, and waxes and/or silicones for slip control, can be useful in various embodiments and contexts. A so-called “soft settle” of the particles is acceptable, but any stabilization of the dispersion would benefit application as the sump would not have to be as thoroughly agitated as is the case for a soft-settling dispersion.

Thus, in exemplary embodiments of the present invention a method of applying an opaque or frost-like textured coating on a substrate can be performed, the method comprising applying a coating solution to the substrate, the coating solution comprising water, an organic binder having a first refractive index, and particles and optionally aggregates thereof having a second refractive index forming a dispersion. The method further includes selecting the binder and the particles so that the second refractive index is greater than the first refractive index by an amount so as to allow for an opaque or frost-like appearance on a substrate coated by the solution after evaporation of a portion of the water and curing of the coating, evaporating a portion of the water from the solution, and curing the solution.

For example, the first refractive index can be between 1.42-1.48, and the second refractive index can be greater than 1.5.

Alternatively, in exemplary embodiments of the present invention a method of applying a transparent textured coating on a substrate can be performed, the method comprising applying a coating solution to the substrate, the coating solution comprising water, an organic binder having a first refractive index, and particles and optionally aggregates thereof having a second refractive index forming a dispersion. The method further includes selecting the binder and the particles so that the second refractive index is approximately equal to the first refractive index by an amount so as to allow for a transparent appearance on a substrate coated by the solution after evaporation of a portion of the water and curing of the coating, evaporating a portion of the water from the solution, and curing the solution.

For example, both the first refractive index and the second refractive index can be between 1.42-1.48.

Still alternatively, in exemplary embodiments of the present invention a method of applying a low gloss textured coating on a substrate can be performed, the method comprising applying a coating solution to the substrate, said coating solution comprising water, an organic binder having a first refractive index, and particles and optionally aggregates thereof having a second refractive index forming a dispersion. The method further includes selecting the binder and the particles so that said second refractive index is greater than the first refractive index by an amount so as to allow for an opaque or frost-like appearance on a substrate coated by the solution after evaporation of a portion of the water and curing of the coating, evaporating a portion of the water from the solution, and curing the solution. The second refractive index can, for example, be only slightly less than the first refractive index, so as to allow for an appearance on the substrate that is both transparent and has either, for example, low gloss, or, for example, ultralow gloss.

For example, the first refractive index can be between 1.42-1.48, and the second refractive index is less than 1.4. Or, for example, the first refractive index can be between 1.43-1.46, and the second refractive index can be between 1.3 and 1.4.

An exemplary coating solution according to the present invention can have, for example, less than 10% VOCs by weight, less than 5% VOCs by weight, less than 3% VOCs by weight, or preferably, no VOCs.

An exemplary coating solution according to the present invention can have a particle loading is greater than 2% by weight, greater than 3% by weight, or, for example, greater than 5% by weight, and the water content of the solution can be one of above 10%, above 20% and above 25%, by weight.

Exemplary embodiments according to the present invention can also include a cured article, comprising a substrate and a cured coating, where the substrate has been coated using any of the methods of the present invention. Additionally, exemplary embodiments according to the present invention can also include an article, comprising a substrate and a coating covering at least one face of the substrate, where the coating is one of the coating solutions according to the present invention. Such an exemplary article can have its coating obtained by
evaporating a portion of the water from the coating solution, and curing the coating solution. For example, the coating can be cured by exposure to at least one of an electron beam and UV light.

The following examples illustrate specific aspects of the present invention and are not intended to limit the scope thereof in any respect and should not be so construed.

### EXAMPLES

The following examples describe low odor, low extractable, radiation cured coatings that vary from frost effect and translucent to ultralow gloss and transparent, depending on the refractive index and loading of the insoluble solid particle(s) used. The coating dispersions can be formed by dissolving water into, for example, epoxy acrylates, glycol acrylates and acrylates of polar alcohols, adding surfactant as required for wetting a substrate, and then adding and dispersing a ground insoluble particle at a critical loading to retain fluidity. Preferably, for example, the particle or an aggregate can have a dimension so as to extend from the surface of the dried film.

### Example 1

### Higher Refractive Index of Particle

To a mixture of 28 g of BASF LR8765 and 13.5 g of Sartomer SR610 (glycol diacrylate) was added 34 g of water with stirring until a clear solution is obtained. To this solution was added 0.5 g BYK 345 surfactant and 2 g of CIBA Ir2959 photoinitiator. Once these have dissolved, 22 g of Ultratalc 609 (refractive index 1.59, GMZ, West Chester, Ohio) is added and dispersed by a 2 minute cycle at 3000 rpm on the DAC 150 FVZ SpeedMixer. This soft-settling preparation was spray applied to a preheated glass surface (for example at 80° C.) and cured by passage under two 200 wpi medium pressure Hg lamps at a belt speed of about 100 fpm. The resulting coating had a frosted, nearly opaque appearance with an 85° gloss of about 5%. It resisted over 35 double rubs with methylethylketone and had a pencil hardness rating of HB.

### Example 2

### Refractive Index Particle Essentially Matches Binder

To 57 g of BASF LR8765 was added 28 g water and 0.5 g BYK345. Following formation of a clear solution, 14.5 g of powdered 2-hydroxyethyl starch (refractive index 1.48, Aldrich Chemical), was added and dispersed by a 2 minute cycle at 3000 rpm on the DAC. This soft-settling preparation was applied to polypropylene film with a #17 wire-wound rod and cured by electron beam in an AEB lab unit at 3.0 Mrad, 235 ppm oxygen. The resulting film was transparent at close distance to a printed surface yet had an 85 deg gloss of about 6%. It resisted over 60 double rubs with methylethylketone, had a kinetic coefficient of friction of about 0.267, a slide angle of about 18 degrees, and passed the 610 tape adhesion test.

### Example 3

### Lower Refractive Index of Particle

To 55 g of BASF LR8765 was added 25 g water and 0.5 g BYK345. Following formation of a clear solution, 15.5 g of powdered hydroxypropyl cellulose (refractive index 1.34, Aqualon, Ashland Chemical) was added and dispersed by a 2 minute cycle at 3000 rpm on the DAC. This soft-settling preparation was applied to polypropylene film with a #17 wire-wound rod and cured by electron beam in an AEB lab unit at 3.0 Mrad, 218 ppm oxygen. The resulting film had an 85° gloss of 3% and was translucent with a white tint.

The present invention has been described in detail, including various exemplary embodiments as well as various preferred exemplary embodiments thereof. However, it will be appreciated that those skilled in the art, upon consideration of the present disclosure, may make modifications and/or improvements on this invention that fall within the scope and spirit of the invention.

1. A method of forming an opaque and/or frost-like, textured appearance of a coating solution on a substrate, comprising:
applying the coating solution according to claim 33 to the substrate;
evaporating the portion of the water from the coating solution; and
curing the coating solution resulting in the opaque and/or frost-like, textured appearance on the substrate.

2. A method of forming a transparent, textured appearance of a coating solution on a substrate, comprising:
applying the coating solution according to claim 34 to the substrate;
evaporating the portion of the water from the coating solution; and
curing the coating solution resulting in the transparent, textured appearance on the substrate.

3. A method of forming a low gloss, textured appearance of a coating solution on a substrate, comprising:
applying the coating solution according to claim 34 to the substrate;
evaporating the portion of the water from the solution so as to expose at least one of the particles and their preformed agglomerates; and
curing the coating solution resulting in the low gloss, textured appearance on the substrate.

4-18. (canceled)

19. The method of claim 1, wherein the textured coating solution is safe for direct food contact.

20. The method of claim 1, wherein the textured coating solution has an extraction result below that allowed by a relevant food packaging regulatory agency for direct food contact.

21-26. (canceled)

27. The method of claim 1, wherein
the water is evaporated prior to and/or during curing, and
said curing includes exposure to at least one of an electron beam and ultraviolet light.

28-32. (canceled)

33. A coating solution, comprising:
water;
an organic binder having a first refractive index; and
particles and optionally aggregates thereof having a second refractive index forming a dispersion,
wherein said second refractive index is greater than said first refractive index, resulting in an opaque and/or frosted, textured appearance of the coating solution on a substrate after evaporation of a portion of the water and curing of the coating solution.

34. A coating solution, comprising:
water;
an organic binder having a first refractive index; and
particles and optionally aggregates thereof having a second refractive index forming a dispersion,
wherein said second refractive index is approximately equal to said first refractive index resulting in a transparent, textured appearance of the coating solution on a substrate after evaporation of a portion of the water and curing of the coating solution.

35. A coating solution, comprising:
water;
an organic binder having a first refractive index; and
particles and optionally aggregates thereof having a second refractive index forming a dispersion,
wherein said second refractive index is less than said first refractive index, resulting in a low-gloss, textured appearance of the coating solution on a substrate after evaporation of a portion of the water and curing of the coating solution.

36. The coating solution of claim 35, wherein said second refractive index is slightly less than said first refractive index, allowing for an appearance that is transparent and has low gloss.

37. The coating solution of claim 33, wherein the first refractive index is between 1.42-1.48, and the second refractive index is greater than 1.5.

38. The coating solution of claim 34, wherein both the first refractive index and the second refractive index are between 1.42-1.48.

39. The coating solution of claim 35, wherein the first refractive index is between 1.42-1.48, and the second refractive index is less than 1.4.

40. The coating solution of claim 37, wherein the particles are talc.

41. The coating solution of claim 38, wherein the particles comprise derivatives of starch and cellulose that have reacted with alkylating agents so as to reduce their compatibility with water.

42. The coating solution of claim 39, wherein the particles comprise perfluorinated ethers and polyolefins.

43. The coating solution of claim 36, wherein the first refractive index is between 1.43-1.46, and the second refractive index is between 1.3 and 1.4.

44. The coating solution of claim 33, wherein the binder comprises at least one of glycol diacrylate and epoxy acrylate.

45. The coating solution of claim 33, wherein the solution contains less than 10% VOCs by weight.

46. The coating solution of claim 33, wherein the solution contains less than 5% VOCs by weight.

47. The coating solution of claim 33, wherein the solution contains less than 3% VOCs by weight.

48. The coating solution of claim 33, wherein the solution contains no VOCs.

49. The coating solution of claim 33, wherein a roughened surface of the coating solution formed by said evaporation and curing.

50. The coating solution of claim 33, wherein said substrate is at least one of glass, metal, wood, paper and plastic.

51. The coating solution of claim 33, wherein the textured coating solution is safe for direct food contact.

52. The coating solution of claim 33, wherein the textured coating solution has an extraction result below that allowed by a relevant food packaging regulatory agency for direct food contact.

53-55. (canceled)

56. The coating solution of claim 33, wherein the particle loading is greater than 5% by weight.

57. The coating solution of claim 33, wherein the water content of the coating solution is at least greater than 10% by weight.

58. The coating solution of claim 33 with a wet thickness larger than an average particle size.

59-60. (canceled)

61. The coating solution of claim 33, wherein the particles are insoluble in the binder and water solution and have at least one dimension that is larger than an anticipated thickness of the cured coating solution on the substrate.

62. (canceled)

63. The coating solution of claim 33, wherein the binder is water-soluble or water-dispersible.

64. The coating solution of claim 33, wherein the binder is radiation curable.

65. A cured article, comprising:
a substrate; and
the cured coating solution according to the method of claim 1.

66. An article, comprising:
a substrate; and
the coating solution according to claim 33 covering at least one face of the substrate.

67-68. (canceled)
